(19) United States
(12) Patent Application Publication
(10) Pub. No.: US 2024/0373173 A1
(43) Pub. Date: Nov. 7, 2024

(54) HEARING AID AND INTRA-ORAL DEVICE THEREOF, EXTERNAL DEVICE, CONTROL METHOD AND CONTROL APPARATUS, AND STORAGE MEDIUM

(71) Applicant: SONITUS MEDICAL (SHANGHAI) CO., LTD., Shanghai (CN)

(72) Inventors: Yang Ji, Shanghai (CN); Qiangling Pu, Shanghai (CN)

(73) Assignee: SONITUS MEDICAL (SHANGHAI) CO., LTD., Shanghai (CN)

(21) Appl. No.: 18/687,268

(22) PCT Filed: Nov. 5, 2021
(86) PCT No.: PCT/CN2021/129054

§ 371 Date: Feb. 27, 2024

(30) Foreign Application Priority Data
Sep. 2, 2021 (CN) 202111028254.0

(51) Int. Cl. H04R 25/00

(52) U.S. Cl. CPC H04R 25/453; H04R 25/606; H04R 2225/61; H04R 2460/13

(57) ABSTRACT

A hearing aid intra-oral device, configured as an intra-orally placed bone conduction sound-transmitting device. The hearing aid intraoral device comprises a vibration apparatus and a detection apparatus, the vibration apparatus being configured to drive the bone conduction sound-transmitting device to vibrate, and the detection apparatus being configured to detect a vibration signal of the bone conduction sound-transmitting device.

### CROSS-REFERENCE TO RELATED APPLICATIONS

The present application is a U.S. National Phase Entry of International PCT Application No. PCT/CN2021/129054 having an international filing date of Nov. 5, 2021, which claims priority to Chinese Patent Application No. 202111028254.0 filed on Sep. 2, 2021. The above-identified applications are incorporated by reference herein in their entireties.

### TECHNICAL FIELD

The present application relates to but is not limited to the field of a hearing aid, and in particular relates to but is not limited to a hearing aid, an intraoral device, an external device, a control method, a control apparatus and a storage medium thereof.

### BACKGROUND

In a hearing aid in some cases, a microphone disposed in a certain range around a skull (such as an ear canal opening, ear canal, skull surface, hairband or hairpin on hair, collar, necklace or pendant, glasses leg or frame, etc.) is usually used to collect a sound signal. After the sound signal collected by the microphone is transmitted to the skull, vibrating of the skull may further drive the ear canal cartilage or skull skin to vibrate, and the vibration signal can be collected again by the microphone and transmitted to the skull, resulting in the occurrence of howling.

### SUMMARY

The following is a summary of the subject matter described in detail herein. This summary is not intended to limit the protection scope of the claims.

A hearing aid intraoral device is configured to be mounted to a bone conduction sound-transmitting organ in a mouth, and the hearing aid intraoral device includes a vibration apparatus configured to be able to drive the bone conduction sound-transmitting organ to vibrate and a detection apparatus configured to detect a vibration signal of the bone conduction sound-transmitting organ.

A hearing aid external device includes a voice collection apparatus and a control apparatus. The control apparatus is configured to be electrically connected with the voice collection apparatus and the aforementioned hearing aid intraoral device. The control apparatus is configured to be able to receive a signal collected by the voice collection apparatus and a vibration signal detected by a detection apparatus of the hearing aid intraoral device, and inversely process the vibration signal detected by the detection apparatus and then superimpose the inversely processed vibration signal with the signal collected by the voice collection apparatus, so as to control a vibration apparatus of the hearing aid intraoral device to vibrate according to the superimposed signal.

A hearing aid includes the aforementioned hearing aid intraoral device and hearing aid external device.

A control method for a hearing aid includes: controlling a voice collection apparatus of a hearing aid external device to collect a sound signal; controlling a detection apparatus of a hearing aid intraoral device to detect a vibration signal of a bone conduction sound-transmitting organ in a mouth; inversely processing the vibration signal detected by the detection apparatus and then superimposing the inversely processed vibration signal with the signal collected by the voice collection apparatus; and controlling a vibration apparatus of the hearing aid intraoral device to vibrate according to the superimposed signal.

A control apparatus of a hearing aid includes a processor and a memory. The memory is used for storing a computer program, and the processor is used for reading and executing the computer program to implement steps of the aforementioned control method.

A non-transient computer-readable storage medium has stored thereon a computer program executable on a processor. Steps of the aforementioned control method for a hearing aid are implemented when the computer program is executed by the processor.

Other aspects will become apparent after reading and understanding the drawings and detailed description.

### BRIEF DESCRIPTION OF DRAWINGS

The drawings are used for providing a further understanding of technical solutions of the present application, and constitute a part of the description. They are used together with embodiments of the present application to explain the technical solutions of the present application, and do not constitute a restriction on the technical solutions of the present application.

FIG. 1 is a schematic cross-sectional view of a hearing aid intraoral device in a usage state in some exemplary embodiments of the present application;

FIG. 2 is a schematic cross-sectional view of a hearing aid intraoral device in a usage state in other exemplary embodiments of the present application;

FIG. 3 is a schematic structural diagram of a hearing aid intraoral device in a usage state in further exemplary embodiments of the present application;

FIG. 4 is a structural block diagram of a hearing aid external device in some exemplary embodiments of the present application;

FIG. 5 is a structural block diagram of a hearing aid in some exemplary embodiments of the present application;

FIG. 6 is a flowchart of a control method for a hearing aid in some exemplary embodiments of the present application; and

FIG. 7 is a structural block diagram of a control apparatus of a hearing aid in some exemplary embodiments of the present application.

### REFERENCE SIGNS

100—hearing aid intraoral device;
1—vibration apparatus, 2—detection apparatus, 3—fixing sleeve, 4—clamping member, 5—bonding portion;
200—bone conduction sound-transmitting organ;
300—hearing aid external device;
6—voice collection apparatus, 7—control apparatus, 71—processor, 72—memory.

### DETAILED DESCRIPTION

Embodiments of the present application will be described below with reference to the drawings. It should be noted that the embodiments in the present application and the features in the embodiments may be arbitrarily combined with each other if there is no conflict.

A purpose of an embodiment of the present application is to provide a hearing aid intraoral device. On the one hand, the hearing aid intraoral device receives a sound signal transmitted from a hearing aid external device, and makes a bone conduction sound-transmitting organ vibrate by means of a vibration apparatus to drive a skull to vibrate, so as to realize the bone conduction transmission of the sound signal. On the other hand, the detection apparatus in the hearing aid intraoral device collects the vibration signal of the bone conduction sound-transmitting organ and transmits it to the hearing aid external device for feedback suppression of sound and preventing the occurrence of howling.

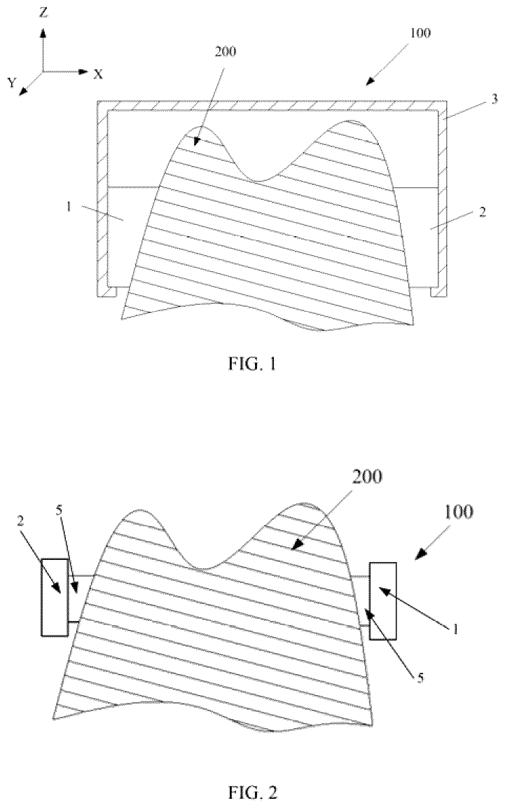

An embodiment of the present application provides a hearing aid intraoral device 100 which is configured to be mounted to a bone conduction sound-transmitting organ 200 in an oral cavity as shown in FIGS. 1-3. The bone conduction sound-transmitting organ 200 may be a tooth or an alveolar bone or other organ, and the hearing aid intraoral device 100 may be mounted to the bone conduction sound-transmitting organ 200 in a stress-coupled manner.

The hearing aid intraoral device 100 is configured to include a vibration apparatus 1 and a detection apparatus 2. The vibration apparatus 1 is configured to be able to drive the bone conduction sound-transmitting organ 200 to vibrate, and the detection apparatus 2 is configured to detect a vibration signal of the bone conduction sound-transmitting organ 200.

The hearing aid intraoral device 100 can be used in conjunction with a hearing aid external device. The hearing aid external device can collect an external sound signal and transmit the sound signal to the vibration apparatus 1. The vibration apparatus 1 can drive the bone conduction sound-transmitting organ 200 to vibrate, and then drive the skull to vibrate, so as to realize a bone conduction transmission of the sound signal.

The vibration of the skull may be collected by the hearing aid external device again. If a bone conduction transmission of the signal occurs through the vibration apparatus 1, it may lead to the occurrence of howling. The detection apparatus 2 can detect a vibration signal of the bone conduction sound-transmitting organ 200 and transmits the vibration signal to the hearing aid external device. The hearing aid external device can perform feedback suppression of the sound signal collected by the hearing aid external device according to the detection signal of the detection apparatus 2, so as to prevent the occurrence of howling.

Compared with an air conduction microphone with the conversion from mechanical energy to electric energy being completed by the vibration of air reaching the microphone, the hearing aid intraoral device 100 of the embodiment of the present application directly collects the vibration signal on the bone conduction sound-transmitting organ 200 disposed in the oral cavity via the detection apparatus, and can collect a self-bone conduction high-definition sound signal in a high-noise environment.

In addition, the detection apparatus 2 for detecting a vibration signal of the bone conduction sound-transmitting organ 200 is not sensitive to air vibration, but only sensitive to a solid vibration signal. Thus, there is no need to design an air conduction path structure, so that a waterproof design of the hearing aid intraoral device 100 is easy to realize, and it has a unique advantage for collecting the vibration bone conduction voice signal in a high noise environment, and can collect the self-bone conduction high-definition sound signal in a high noise environment.

In some exemplary embodiments, the detection apparatus 2 is configured to include at least one acceleration sensor. The acceleration sensor is a kind of sensor that can measure acceleration, which can be composed of a mass block, a damper, an elastic element, a sensitive element and an adaptive circuit, etc. According to the different sensitive elements of the sensors, common acceleration sensors include a capacitive type sensor, an inductive type sensor, a strain type sensor, a piezoresistive type sensor, a piezoelectric type sensor, etc., and the types of sensors are not limited here.

Because the acceleration sensor is only sensitive to a vibration signal, there is no need to design an air conduction path structure. Since the acceleration sensor does not require an air conduction path structure design, the waterproof design of the hearing aid intraoral device 100 is particularly easy, and the design can be simplified, thereby reducing the manufacturing cost. The acceleration sensor is sensitive to solid vibration and insensitive to air vibration, so it has a unique advantage for collecting a vibration bone conduction voice signal in high noise environment.

At least one acceleration sensor is provided to detect vibration in at least one of a first direction, a second direction, and a third direction. That is, the vibration signal in only one direction may be detected, or the vibrations in two directions or in three directions may be detected, thereby improving the flexibility of use of the hearing aid intraoral device 100. The first direction, the second direction and the third direction are pairwise perpendicular to each other. That is, the first direction, the second direction and the third direction described above together form a three-dimensional coordinate system in the space. As shown in FIG. 1, the first direction can be set as X direction (a direction that the human body faces, that is, a front and back direction), the second direction can be set as Y direction (a width direction of the human body, that is, a left and right direction), and the third direction can be set as Z direction (a height direction of the human body, that is, an up and down direction). Alternatively, the first direction, the second direction and the third direction are not limited to the foregoing.

For example, at least one acceleration sensor can realize a vibration detection in all of the first direction, the second direction, and the third direction, and then combine vibration signals in the three directions, so that the sound can be reproduced well and has a certain clarity.

In some exemplary embodiments, in order to realize the above-described detection of vibration signals in different directions, the acceleration sensor may be provided as one of a uniaxial acceleration sensor, a biaxial acceleration sensor, or a triaxial acceleration sensor, or a combination of several acceleration sensors, and the plurality of acceleration sensors may be mounted to the bone conduction sound-transmitting organ 200 in a superimposed manner. The uniaxial acceleration sensor and the triaxial acceleration sensor have their own advantages. The uniaxial acceleration sensor has stronger directivity, while the triaxial acceleration sensor can superimpose and organize all vibration signals to realize signal collection with good reproduction effect, natural sound quality, good balance and high fidelity.

In some exemplary embodiments, the detection apparatus 2 may also be configured to include a plurality of acceleration sensors with different bandwidths for detecting vibration in the same direction (which may be one direction or two directions or three directions).

For example, for the first direction (e.g. X direction), two acceleration sensors with different bandwidths (which can be uniaxial acceleration sensors) are used to collect low frequency and medium-high frequency signals along X direction respectively, or collect medium-low frequency and high frequency signals along X direction respectively. The coordination of acceleration sensors with different bandwidths described above realizes a full-frequency detection of signals in the set direction, improves the detection bandwidth, and also improves the detection accuracy. A certain overlap of frequency values can also be set between the detection frequencies of a plurality of bandwidths to avoid frequency leakage.

For example, for the first direction (e.g. X direction) and the second direction (e.g. Y direction), two acceleration sensors (which may be uniaxial acceleration sensors) with different bandwidths are used in each direction to collect low frequency and medium-high frequency signals in X direction and low frequency and medium-high frequency signals in Y direction respectively, or to collect medium-low frequency and high frequency signals in X direction and medium-low frequency and high frequency signals in Y direction respectively. Operating frequency bands of the acceleration sensors for collecting low frequency or medium-low frequency signals in two directions may be set to be the same or different, and operating frequency bands of the acceleration sensors for collecting high frequency or medium-high frequency signals in two directions may be set to be the same or different.

Alternatively, for the first direction (e.g. X direction) and the second direction (e.g. Y direction), two acceleration sensors (which may be biaxial acceleration sensors) with different bandwidths can be used to collect low frequency signals along X direction and Y direction, and medium-high frequency signals along X direction and Y direction respectively, or collect medium-low frequency signals along X direction and Y direction, and high frequency signals along X direction and Y direction, respectively.

It should be understood that the detection apparatus 2 may use other vibration sensors capable of detecting vibration such as a piezoelectric sensor or the like in addition to using the acceleration sensor(s) to collect a vibration signal of a tooth or an alveolar bone.

Since a piezoelectric oscillator has many advantages such as low energy consumption, no electromagnetic radiation and easy miniaturization, in some exemplary embodiments the vibration apparatus 1 may be configured to include a piezoelectric oscillator. In addition, a cross-sectional shape of the piezoelectric oscillator can be configured to be rectangular or circular and the like.

In some exemplary embodiments, the hearing aid intraoral device 100 is configured to further include a power supply apparatus (not shown in the figures) and a circuit board (not shown). Both the vibration apparatus 1 and the detection apparatus 2 are configured to be electrically connected with the circuit board, the power supply apparatus is configured to supply power to the vibration apparatus 1 and the detection apparatus 2, and the power supply apparatus, the circuit board and the detection apparatus 2 are assembled and fixed together.

The bone conduction sound-transmitting organ 200 may be provided as a tooth. The power supply apparatus, the circuit board, and the detection apparatus 2 are configured to be installed on one side of the tooth (e.g. a crown) (e.g. a lingual side near a tongue), and the vibration apparatus 1 is configured to be installed on the other side of the tooth (e.g. a crown) (e.g. a buccal side near a cheek).

It should be understood that the power supply apparatus, the circuit board and the detection apparatus 2, and the vibration apparatus 1 may be disposed on opposite sides of the tooth, or on adjacent sides of the tooth, or on the same side of the tooth, etc.

In some exemplary embodiments, the hearing aid intraoral device 100 may be configured to further include a fixing sleeve 3. Both the vibration apparatus 1 and the detection apparatus 2 are configured to be fixed to the aforementioned fixing sleeve 3. The fixing sleeve 3 can be selectively made of elastic plastic, and the vibration apparatus 1 and the detection apparatus 2 can be fixed on an inner wall surface or an outer wall surface of the fixing sleeve 3. As shown in FIG. 1, the fixing sleeve 3 is configured to be sleeved onto at least one tooth (such as a crown of one tooth or two teeth). That is, a concave-convex-like insertion fit is formed between the fixing sleeve 3 and the tooth, so that the installation of the hearing aid intraoral device 100 is firm and the appearance is aesthetic. The vibration apparatus 1 and the detection apparatus 2 are respectively fixed on both sides in the fixing sleeve 3.

The fixing sleeve 3 is manufactured to have a shrinkage such that when the fixing sleeve 3 is sleeved onto the tooth, the fixing sleeve 3 can be firmly clamped on the tooth. The size of the fixing sleeve 3 may be slightly smaller than the size of the tooth to be sleeved, so as to create a firm interference fit between the fixing sleeve 3 and at least two surfaces of at least one tooth.

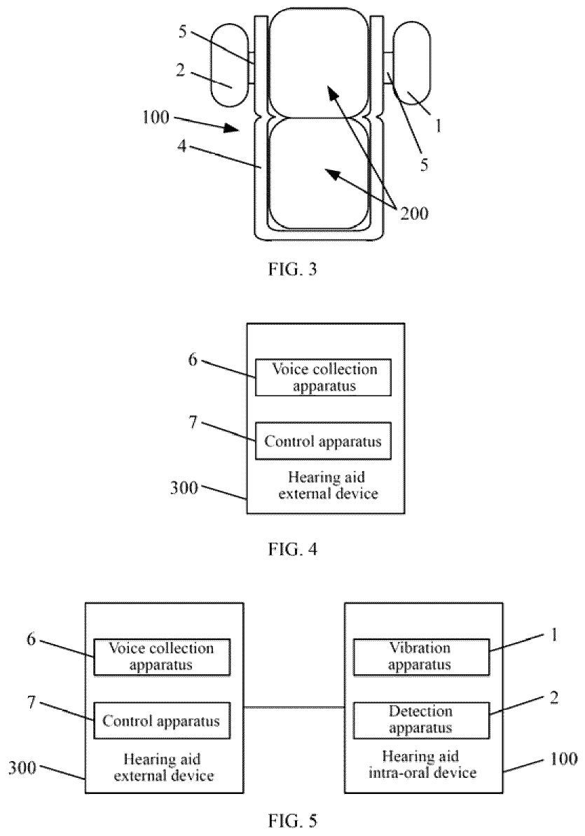

In other exemplary embodiments, as shown in FIG. 3, the hearing aid intraoral device 100 further includes a clamping member 4 to which both the vibration apparatus 1 and the detection apparatus 2 are configured to be fixed. The clamping member 4 may be provided as a metal or non-metal elastic clamping member (e.g. the clamping member 4 may be a steel pipe structure) so that the clamping member 4 can be elastically deformed. The clamping member 4 is clamped to at least one tooth (such as a crown of one tooth or two teeth), the clamping member 4 can be deformed and in interference fit with at least two surfaces of at least one tooth, so that the clamping member 4 is firmly clamped on at least one tooth. The mounting stability of the hearing aid intraoral device 100 can be improved. When the clamping member 4 is clamped on at least one tooth, the clamping member 4 can surround the at least one tooth.

The vibration apparatus 1 and the detection apparatus 2 can be bonded to both sides of the clamping member 4 by the bonding portions 5 or fixed to the clamping member 4 by other means.

The vibration apparatus 1 and the detection apparatus 2 can be fixed on the outside of the clamping member 4 (i.e. a side facing away from the tooth), so that the vibration apparatus 1 can drive the tooth to vibrate via the clamping member 4, and the detection apparatus 2 can detect the vibration transmitted by the tooth to the clamping member 4. Alternatively, the vibration apparatus 1 and the detection apparatus 2 may be fixed on the inside of the clamping member 4 (i.e. between the clamping member 4 and the tooth), so that the vibration apparatus 1 may directly drive the tooth to vibrate or drive the tooth to vibrate via the clamping member 4, and the detection apparatus 2 may directly detect the vibration of the tooth or detect the vibration transmitted by the tooth to the clamping member 4.

Alternatively, as shown in FIG. 2, the vibration apparatus 1 and the detection apparatus 2 are configured to directly bond to the bone conduction sound-transmitting organ 200. That is, bonding portions 5 are disposed on the vibration apparatus 1 and the detection apparatus 2. The vibration apparatus 1 and the detection apparatus 2 are fixed to both sides of a tooth (such as a crown of one tooth or two teeth) by the bonding portions 5, and sides of the bonding portions 5 close to the tooth fit with the outer surfaces of the tooth, so as to improve the mounting firmness.

The diversified installation modes of the hearing aid intraoral device 100 described above can increase the diversity of products, thereby satisfying the usage habits and requirements of different users.

In some exemplary embodiments, the vibration apparatus 1 is configured to transmit vibration to at least one tooth, and the detection apparatus 2 is configured to detect the vibration signal of at least one tooth. The vibration of the vibration apparatus 1 and the detection of the detection apparatus 2 are synchronized. That is, the vibration apparatus 1 and the detection apparatus 2 are configured to transmit vibration to the surface of at least one tooth and detect the vibration signal of at least one tooth synchronously.

The tooth to which the vibration is transmitted by the vibration apparatus 1 and the tooth of which the vibration is detected by the detection apparatus 2 may be the same tooth. For example, the vibration apparatus 1 transmits vibration to one tooth or two teeth, and the detection apparatus 2 synchronously detects a vibration signal of the one tooth or two teeth. Alternatively, the tooth to which the vibration is transmitted by the vibration apparatus 1 and the tooth of which the vibration is detected by the detection apparatus 2 may be different teeth. For example, the vibration apparatus 1 transmits vibration to one tooth or two teeth, and the detection apparatus 2 synchronously detects a vibration signal of the other tooth or two teeth.

In another embodiment of the present application, as shown in FIG. 4, a hearing aid external device 300 is also provided. The hearing aid external device 300 includes a voice collection apparatus 6 and a control apparatus 7. The control apparatus 7 is configured to be electrically connected with the voice collection apparatus 6 and the hearing aid intraoral device 100.

The control apparatus 7 is configured to receive a signal collected by the voice collection apparatus 6 and a vibration signal detected by the detection apparatus 2 of the hearing aid intraoral device 100, inversely process the vibration signal detected by the detection apparatus 2 and then superimpose the inversely processed vibration signal with the signal collected by the voice collection apparatus 6, so as to control the vibration apparatus 1 of the hearing aid intraoral device 100 to vibrate according to the superimposed signal.

That is, an external sound signal is collected by the voice collection apparatus 6, and then transmitted to the hearing aid intraoral device 100, the vibration apparatus 1 is driven to vibrate, and then the tooth and skull are driven to vibrate, so that the human receives the sound signal. The voice collection apparatus 6 is generally disposed and installed in the ear canal, which is in the skull, so that the vibration of the skull can also be collected by the voice collection apparatus 6, and the signal may be transmitted to the vibration apparatus 1 again.

Therefore, the detection apparatus 2 collects the vibration signal of the tooth and transmits it to the control apparatus 7 of the hearing aid external device 300. The control apparatus 7 performs inverse processing on the vibration signal detected by the detection apparatus 2, and then superimposes the inversely processed vibration signal with the signal collected by the voice collection apparatus 6. A part of the signals collected by the voice collection apparatus 6 that are consistent with the signals collected by the detection apparatus 2 can be suppressed (the transmitted sound signal can be cancelled out to avoid secondary sound transmission), which can effectively prevent the occurrence of howling and improve the transmission quality of the sound signal.

The voice collection apparatus 6 can be configured to include a common microphone, that is, the external sound is collected by the microphone, resulting in a mature product structure, a stable performance and a convenient selection. The microphone is an air conduction microphone.

In yet another embodiment of the present application, as shown in FIG. 5, a hearing aid is also provided. The hearing aid includes a hearing aid intraoral device 100 and a hearing aid external device 300.

For a hearing aid in an embodiment of the present application, a hearing aid intraoral device is configured to be installed to a bone conduction sound-transmitting organ (such as tooth, alveolar bone, etc.) in the mouth. The hearing aid intraoral device can receive the sound signal collected by a hearing aid external device, and drive the bone conduction sound-transmitting organ to vibrate through the vibration of the vibration apparatus, thereby driving the skull to vibrate, so as to realize the bone conduction transmission of the sound signal. The detection apparatus can detect the vibration signal of the bone conduction sound-transmitting organ and transmit the vibration signal to the hearing aid external device for feedback suppression of sound and preventing the occurrence of howling.

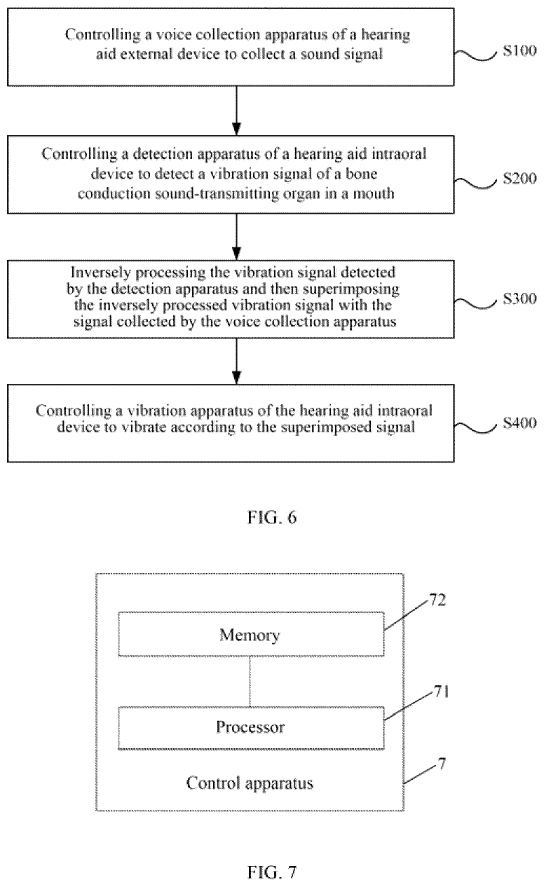

In another embodiment of the present application, as shown in FIG. 6, a control method for a hearing aid is also provided. The method includes:

S100: controlling a voice collection apparatus of a hearing aid external device to collect a sound signal;

S200: controlling a detection apparatus of a hearing aid intraoral device to detect a vibration signal of a bone conduction sound-transmitting organ in a mouth;

S300: inversely processing the vibration signal detected by the detection apparatus, and then superimposing the inversely processed vibration signal with the signal collected by the voice collection apparatus; and

S400: controlling the vibration apparatus of the hearing aid intraoral device to vibrate according to the superimposed signal.

After the voice collection apparatus 6 and the detection apparatus 2 respectively collect the air conduction sound signal and the vibration signal of the solid (bone conduction sound-transmitting organ), the vibration signal detected by the detection apparatus 2 is inversely processed. Then, the inversely processed vibration signal and the signal collected by the voice collection apparatus 6 are superimposed. In this way, the sound signal collected by the voice collection apparatus 6 and transmitted from the skull to the ear canal can be suppressed, the occurrence of howling can be effectively prevented, and the transmission quality of the sound signal can be improved.

It should be noted that the collection of the sound signal by the voice collection apparatus 6 and the detection of the vibration signal by the detection apparatus 2 may be carried out simultaneously without sequential relationship. The vibration signal of the detection apparatus 2 to be inversely processed and the signal collected by the sound collection device 6 and to be superimposed may be simultaneously transmitted to the control apparatus 7, or there may be a certain time delay between them.

In yet another embodiment of the present application, as shown in FIG. 7, a control apparatus 7 for a hearing aid is also provided. The control apparatus 7 includes a processor 71 and a memory 72. The memory 72 is used for storing a computer program, and the processor 71 is used for reading and executing the computer program, so as to implement steps of the aforementioned control method.

In order to reduce the volume of the hearing aid intraoral device 100, that is, to make it be thin and light, the control apparatus of the hearing aid described above can be disposed in the hearing aid external device 300, which also can improve the integrity of the product.

In another embodiment of the present application, a non-transient computer-readable storage medium is also provided, on which a computer program that can be run on a processor is stored. When the computer program is executed by the processor, steps of the control method of the hearing aid described above can be implemented.

In the description of the present application, it should be noted that the orientation or position relationships indicated by the terms “upper”, “lower”, “one side”, “the other side”, “one end”, “the other end”, “edge”, “relative”, “four corners”, “periphery” and “square structure” or the like are based on the orientation or position relationships shown in the drawings, which are only for convenience of describing the present application and simplifying the description, rather than indicating or implying that the structure referred has a specific orientation, or is constructed and operated in the specific orientation, and thus cannot be interpreted as a limitation on the present application.

In the description herein, it should be noted that the term “multiple/a plurality of” refers to two or more.

In the description of embodiments of the present application, the terms “connection”, “fix”, and “mounting” and the like should be understood broadly, unless otherwise expressly specified and limited. For example, “connection” may be a fixed connection, may be a detachable connection, or may be an integrated connection. “Connection” may be direct connection or indirect connection through an intermediate medium, or may be an internal communication between two elements. For those of ordinary skills in the art, the specific meanings of the aforementioned terms in the present application may be understood according to specific situations.

It may be understood by those of ordinary skill in the art that all or some steps in a method and function modules/units in a system and an apparatus disclosed in the above description may be implemented as software, firmware, hardware, or an appropriate combination thereof. In a hardware implementation, division of the function modules/units mentioned in the above description does not necessarily correspond to division of physical assemblies. For example, a physical assembly may have multiple functions, or a function or a step may be executed by several physical assemblies in cooperation. Some assemblies or all assemblies may be implemented as software executed by a processor such as a digital signal processor or a microprocessor, or implemented as hardware, or implemented as an integrated circuit such as an application specific integrated circuit. Such software may be distributed in a computer-readable medium, and the computer-readable medium may include a computer storage medium (or a non-transitory medium) and a communication medium (or a transitory medium). As known to those of ordinary skill in the art, a term “computer storage medium” includes volatile and nonvolatile, and removable and irremovable media implemented in any method or technology for storing information (for example, computer-readable instructions, a data structure, a program module, or other data). The computer storage medium includes, but is not limited to, RAM, ROM, EEPROM, a flash memory, or another memory technology, CD-ROM, a Digital Versatile Disk (DVD) or another optical disk storage, a magnetic box, a magnetic tape, magnetic disk storage or another magnetic storage apparatus, or any other media that may be used for storing desired information and may be accessed by a computer. In addition, it is known to those of ordinary skill in the art that the communication medium usually includes computer-readable instructions, a data structure, a program module, or other data in a modulated data signal such as a carrier or another transmission mechanism, and may include any information delivery medium. Furthermore, when describing representative embodiments, the description may have presented a method and/or process as a particular sequence of steps. However, to the extent that the method or process does not depend on the specific order of steps described herein, the method or process should not be limited to the specific order of steps described. As will be understood by those of ordinary skill in the art, other order of steps is also possible. Accordingly, a particular order of steps set forth in the description should not be construed as limitations on the claims. Furthermore, the claims for the method and/or process should not be limited to the steps which are performed in the written order. Those skilled in the art can readily understand that these orders can be changed and the changed orders still remain within the spirit and scope of the embodiments of the present application.

Although implementations disclosed herein are described above, the described contents are only implementations used for facilitating understanding of the present application, and are not intended to limit the present application. Without departing from the spirit and scope disclosed herein, any person skilled in the art to which the present application pertains may make any modifications and changes in the form and details of implementation, but the scope of patent protection of the present application shall still be defined by the appended claims.

What we claim is:

1. A hearing aid intraoral device configured to be mounted to a bone conduction sound-transmitting organ in a mouth, the hearing aid intraoral device comprising a vibration apparatus configured to be able to drive the bone conduction sound-transmitting organ to vibrate and a detection apparatus configured to detect a vibration signal of the bone conduction sound-transmitting organ.

2. The hearing aid intraoral device according to claim 1, wherein the detection apparatus comprises at least one acceleration sensor configured to detect vibration in at least one of a first direction, a second direction, and a third direction, wherein the first direction, the second direction, and the third direction are pairwise perpendicular to each other.

3. The hearing aid intraoral device according to claim 2, wherein the acceleration sensor is a uniaxial acceleration sensor, a biaxial acceleration sensor, or a triaxial acceleration sensor.

4. The hearing aid intraoral device according to claim 1, wherein the detection apparatus comprises a plurality of acceleration sensors with different bandwidths for detecting vibrations in the same direction.

5. The hearing aid intraoral device according to claim 1, wherein the vibration apparatus comprises a piezoelectric oscillator.

6. The hearing aid intraoral device according to claim 1, further comprising a power supply apparatus and a circuit board, wherein the vibration apparatus and the detection apparatus both are electrically connected to the circuit board, the power supply apparatus is configured to supply power to the vibration apparatus and the detection apparatus; and the power supply apparatus, the circuit board and the detection apparatus are assembled and fixed together.

7. The hearing aid intraoral device according to claim 6, wherein the bone conduction sound-transmitting organ is a tooth, the power supply apparatus, the circuit board, and the detection apparatus are configured to be mounted to one side of the tooth, the vibration apparatus is configured to be mounted to the other side of the tooth, and the vibration apparatus and the detection apparatus are configured to synchronously transmit vibration to a surface of at least one tooth and detect a vibration signal of the at least one tooth.

8. The hearing aid intraoral device according to claim 1, wherein the hearing aid intraoral device further comprises a fixing sleeve to which both the vibration apparatus and the detection apparatus are fixed, the bone conduction sound-transmitting organ is a tooth, and the fixing sleeve is configured to be sleeved onto the tooth; or
the hearing aid intraoral device further comprises a clamping member to which both the vibration apparatus and the detection apparatus are fixed, the bone conduction sound-transmitting organ is a tooth, and the clamping member is configured to be clamped on the tooth and in interference fit with a surface of the tooth; or
the vibration apparatus and the detection apparatus each are provided with a bonding portion, the bone conduction sound-transmitting organ is a tooth, and the vibration apparatus and the detection apparatus are configured to be bonded to the tooth.

9. A hearing aid external device comprising a voice collection apparatus and a control apparatus, the control apparatus being configured to be electrically connected with the voice collection apparatus and the hearing aid intraoral device according to claim 1;
wherein the control apparatus is configured to be able to receive a signal collected by the voice collection apparatus and a vibration signal detected by the detection apparatus of the hearing aid intraoral device, and inversely process the vibration signal detected by the detection apparatus and then superimpose the inversely processed vibration signal with the signal collected by the voice collection apparatus, so as to control the vibration apparatus of the hearing aid intraoral device to vibrate according to the superimposed signal.

10. The hearing aid external device according to claim 9, wherein the voice collection apparatus comprises a microphone.

11. A hearing aid comprising the hearing aid intraoral device according to claim 1 and the a hearing aid external device, wherein the hearing aid external device comprises a voice collection apparatus and a control apparatus, the control apparatus is configured to be electrically connected with the voice collection apparatus and the hearing aid intraoral device;
wherein the control apparatus is configured to be able to receive a signal collected by the voice collection apparatus and a vibration signal detected by the detection apparatus of the hearing aid intraoral device, and inversely process the vibration signal detected by the detection apparatus and then superimpose the inversely processed vibration signal with the signal collected by the voice collection apparatus, so as to control the vibration apparatus of the hearing aid intraoral device to vibrate according to the superimposed signal.

12. A control method for a hearing aid, comprising:
controlling a voice collection apparatus of a hearing aid external device to collect a sound signal;
controlling a detection apparatus of a hearing aid intraoral device to detect a vibration signal of a bone conduction sound-transmitting organ in a mouth;
inversely processing the vibration signal detected by the detection apparatus and then superimposing the inversely processed vibration signal with the signal collected by the voice collection apparatus; and
controlling a vibration apparatus of the hearing aid intraoral device to vibrate according to the superimposed signal.

13. A control apparatus for a hearing aid, comprising a processor and a memory;
wherein the memory is used for storing a computer program, and the processor is used for reading and executing the computer program to implement steps of the control method according to claim 12.

14. A non-transient computer-readable storage medium having stored thereon a computer program executable on a processor, wherein steps of the control method for a hearing aid according to claim 12 are implemented when the computer program is executed by the processor.

15. The hearing aid intraoral device according to claim 2, wherein the vibration apparatus comprises a piezoelectric oscillator.

16. The hearing aid intraoral device according to claim 3, wherein the vibration apparatus comprises a piezoelectric oscillator.

17. The hearing aid intraoral device according to claim 2, further comprising a power supply apparatus and a circuit board, wherein the vibration apparatus and the detection apparatus both are electrically connected to the circuit board, the power supply apparatus is configured to supply power to the vibration apparatus and the detection apparatus, and the power supply apparatus, the circuit board and the detection apparatus are assembled and fixed together.

18. The hearing aid intraoral device according to claim 3, further comprising a power supply apparatus and a circuit board, wherein the vibration apparatus and the detection apparatus both are electrically connected to the circuit board, the power supply apparatus is configured to supply power to the vibration apparatus and the detection apparatus, and the power supply apparatus, the circuit board and the detection apparatus are assembled and fixed together.

19. The hearing aid intraoral device according to claim 2, wherein the hearing aid intraoral device further comprises a fixing sleeve to which both the vibration apparatus and the detection apparatus are fixed, the bone conduction sound-transmitting organ is a tooth, and the fixing sleeve is configured to be sleeved onto the tooth; or
the hearing aid intraoral device further comprises a clamping member to which both the vibration apparatus and the detection apparatus are fixed, the bone conduction sound-transmitting organ is a tooth, and the clamping member is configured to be clamped on
the tooth and in interference fit with a surface of the tooth; or the vibration apparatus and the detection apparatus each are provided with a bonding portion, the bone conduction sound-transmitting organ is a tooth, and the vibration apparatus and the detection apparatus are configured to be bonded to the tooth.

20. The hearing aid intraoral device according to claim 3, wherein the hearing aid intraoral device further comprises a fixing sleeve to which both the vibration apparatus and the detection apparatus are fixed, the bone conduction sound-transmitting organ is a tooth, and the fixing sleeve is configured to be sleeved onto the tooth; or
the hearing aid intraoral device further comprises a clamping member to which both the vibration apparatus and the detection apparatus are fixed, the bone conduction sound-transmitting organ is a tooth, and the clamping member is configured to be clamped on the tooth and in interference fit with a surface of the tooth; or
the vibration apparatus and the detection apparatus each are provided with a bonding portion, the bone conduction sound-transmitting organ is a tooth, and the vibration apparatus and the detection apparatus are configured to be bonded to the tooth.
